(19) United States
(12) Patent Application Publication
(10) Pub. No.: US 2022/0139180 A1
(43) Pub. Date: May 5, 2022

(54) CUSTOM EVENT DETECTION FOR SURVEILLANCE CAMERAS

(71) Applicant: Visual One Technologies Inc., San Francisco, CA (US)

(72) Inventor: Mohammad Rafiee JAHROMI, Truckee, CA (US)

(21) Appl. No.: 17/513,691

(22) Filed: Oct. 28, 2021

Related U.S. Application Data
(60) Provisional application No. 63/107,255, filed on Oct. 29, 2020.

(51) Int. Cl. G08B 13/196; G06V 20/40; G06V 10/70

(52) U.S. Cl. CPC G08B 13/19613; G06V 10/70; G06V 20/44

(57) ABSTRACT

A system trains and uses event recognition models for recognizing custom events types defined by a user within a camera feed of a surveillance camera, The camera can be fixed-view, with a relatively constant position and angle, and the background of the video images video can be likewise relatively constant. A user interface receives, from a user, positive and negative samples of the event in question, such as a designation of live or pre-recorded portions of a camera feed as being positive or negative examples of the event in question. Based on the samples, the user system trains an event recognition model (e.g., using few-shot learning techniques) to detect occurrences of custom event types in the camera feed. A response is performed based on detected occurrences of the event. The user can flag mistakes (false positive or false negative) which can be incorporated into the model to enhance its accuracy.

### CROSS-REFERENCES TO RELATED APPLICATIONS

The present application claims the benefit of U.S. Provisional Application No. 63/107,255, titled “Training Custom Event-Detection for Surveillance Cameras,” filed Oct. 29, 2020. The subject matter of this related application is hereby incorporated herein by reference.

### BACKGROUND

### Field of the Various Embodiments

This disclosure relates generally to the field of electronic data processing, and more specifically, to custom event detection for surveillance cameras.

### Description of the Related Art

Many users have (or can easily obtain) surveillance cameras for their homes or other locations to monitor the state of those locations, Users may wish that particular events—such as a pet hopping on a couch or otherwise misbehaving, a person picking up a package or other comparatively complex events—could be recognized by such systems. However, recognizing events is much more complex than recognizing individual static objects, and camera visual recognition systems have thus far been limited to the latter type.

As the foregoing illustrates what is needed are improved techniques for custom event detection for surveillance cameras.

### SUMMARY

In some embodiments, a computer-implemented method for detecting events by a video camera includes accessing a training data set of training data samples, each training data sample including at least one image obtained from the video camera and an indication of an occurrence of an event within the at least one image; training an event recognition model to generate the indication of the occurrence of the event within each training data sample of the training data set; applying the event recognition model to a camera feed of the video camera to generate an indication of an occurrence of the event in the camera feed; and performing a response based on the indication of the occurrence of the event in the camera feed.

In some embodiments, one or more non-transitory computer readable media stores instructions that, when executed by one or more processors, cause the one or more processors to perform the steps of accessing a training data set of training data samples, each training data sample including at least one image obtained from a video camera and an indication of an occurrence of an event within the at least one image; training an event recognition model to generate the indication of the occurrence of the event within each training data sample of the training data set; applying the event recognition model to a camera feed of the video camera to generate an indication of an occurrence of the event in the camera feed; and performing a response based on the indication of the occurrence of the event in the camera feed.

In some embodiments, a system includes a memory that stores instructions, and a processor that is coupled to the memory and, when executing the instructions, is configured to access a training data set of training data samples, each training data sample including at least one image obtained from a video camera and an indication of an occurrence of an event within the at least one image; train an event recognition model to generate the indication of the occurrence of the event within each training data sample of the training data set; apply the event recognition model to a camera feed of the video camera to generate an indication of an occurrence of the event in the camera feed; and perform a response based on the indication of the occurrence of the event in the camera feed.

At least one technical advantage of the disclosed techniques is that the event recognition model is trained to detect specific types of events that indicated by the user. Training the event recognition model based on events that are of interest to the user can expand and focus the range of detected event types to those that are of particular interest to the user, and to exclude events that are not of interest to the user. As another advantage, training the event recognition model on the camera feed of a camera can enable the camera to detect events within the particular context of the camera and camera feed, such as a particular room of a house or area of a factory. As yet another advantage, performing responses based on the trained event recognition model can enable a surveillance system to take event-type-specific responses based on the events of interest to the user. These technical advantages provide one or more technological improvements over existing techniques for event detection for surveillance cameras.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a system configured to implement one or more embodiments;

FIG. 2 is an illustration of a user interface of the system of FIG. 1, according to some embodiments;

FIG. 3 is an illustration of the system of FIG. 1 detecting events in a monitored scene, according to some embodiments; and

FIG. 4 is a flow diagram of method steps for detecting events by a video camera, according to one or more embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

The disclosed embodiments involve the use of event recognition models to recognize events that are visible to surveillance cameras. Surveillance cameras are widely used for consumer, commercial, and industrial applications. In such scenarios, basic event detection framework (based on motion detection or specific objects detection such as person detection) can lead to many false alarms. For example, a user who is using a doorbell or a camera at their home entrance may not be interested to know every time there is a motion at their door or every time a person is passing by which could result in hundreds of alerts per day. The techniques disclosed herein provide a custom event detection in which an event recognition model is trained to determine occurrences of events that a user cares about, such as a person picking up a package, which can significantly reduce the number of false alarms.

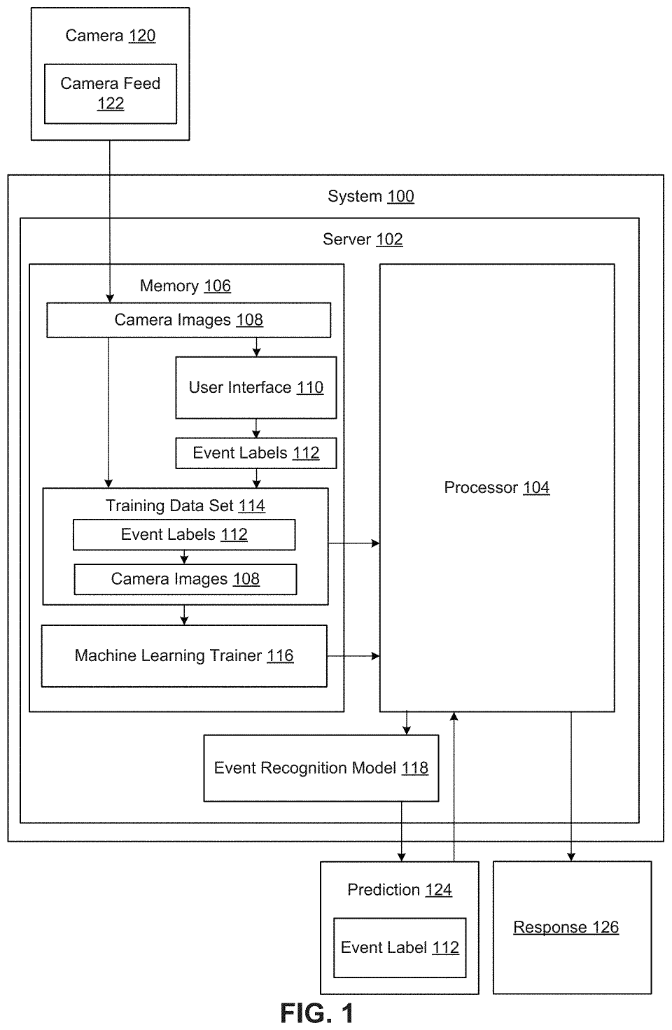

FIG. 1 is a system 100 configured to implement one or more embodiments. As shown, a server 102 within system 100 includes a processor 104, a memory 106, and an event recognition model 118. The memory 106 includes a data sample set 106, including one or more event labels 112 associated with each of one or more camera images 108. The memory 106 includes a set of camera images 108, a user interface 110, one or more event labels 112, a training data set 114, and a machine learning trainer 116. The server 102 interacts with a camera 120 that generates a camera feed 122, As shown, the system 100 interacts with the camera 120, but in some embodiments (not shown), the camera 120 is included in the system 100.

The camera 120 produces a camera feed 122 of camera images 108, which can be individual images and/or video segments including a sequence of two or more images. The camera 120 can produce a camera feed of a monitored scene 130, such as a portion of the user's home such as a living room or deck, commercial space, a factory assembly line, or the like. In some embodiments, the camera 120 is used in a fixed view manner, in that that its position and orientation do not change (or change very little) during its use, so that the area captured by the camera is relatively constant, and thus the background image also tends to be constant (assuming that the background itself is essentially static, such as a wall, a deck or other scene with primarily stationary objects). For example (without limitation), a typical security camera has a fixed (or nearly-fixed) viewpoint, Thus, in such cases, after a surveillance camera is installed, the scene/environment stays the same and the background is mostly constant except for slight changes in the angle or location of the camera. The relatively unchanging viewpoint and background of a surveillance camera can make it possible to identify events with greater precision than would be possible in other contexts with more movement and variation.

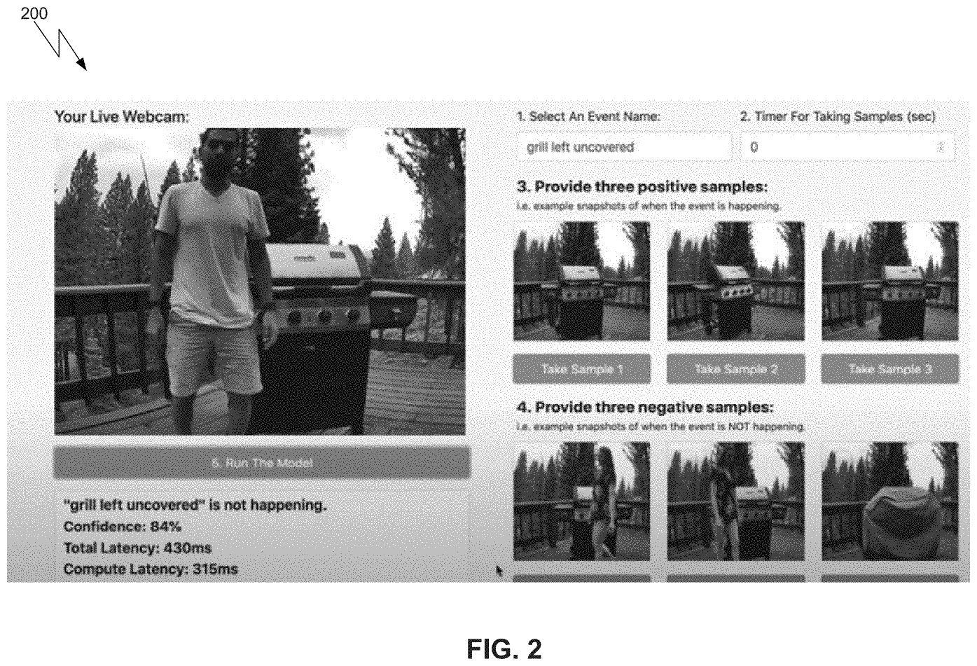

For each of the still images and/or video segments, the processor 140 executes the user interface 110 to receive, from a user, a selection of an event label 112 as an indication of an occurrence of an event within the image and/or video segment. In some embodiments, the user indicates a portion of an image in which the event occurs, such as a rectangular or free-form boundary designating an area of the image in which the occurrence of the event is visible. In some embodiments, the user indicates a portion of a video segment in which the event occurs, such as a rectangular or free-form boundary designating an area of the video segment in which the event occurs, and/or a subset of the two or more images during which the event occurs. Some embodiments of the user interface are further shown in FIG. 2.

The event labels 112 selected for the one or more camera images 108 of the training data set 114 can include a variety of event types in a variety of use cases. In some embodiments, the system 100 allows users of surveillance cameras to create custom alerts for specific events they care about. As an example (without limitation), in home monitoring scenarios, events that can be visible to a surveillance camera and recognized include an entrance door being left open, a faucet being left running, a person dropping off or picking up a package from a porch, a garage door left open, a car door left open, a person getting into a car in the driveway, a light being left on, and/or a hot tub being left uncovered. As an example (without limitation), in pet care scenarios, events that can be visible to a surveillance camera and recognized include a dog getting on furniture, a dog chewing on shoes, a dog defecating in the house, and/or a cat scratching the couch. As an example (without limitation), in elderly care scenarios, events that can be visible to a surveillance camera and recognized include an elderly person falling and/or an elderly taking medications. As an example (without limitation), in childcare scenarios, events that can be visible to a surveillance camera and recognized include a toddler climbing furniture, an infant lying on its stomach, and/or a kid playing with a knife. As an example (without limitation), in commercial scenarios (e.g., security in stores, malls, airports, train stations, patient care), events that can be visible to a surveillance camera and recognized include luggage being left unattended in an airport terminal, a person carrying a large item onto a train, and/or a person carrying a weapon into a mall. As an example (without limitation), in industrial scenarios (e.g.. manufacturing/assembly lines, power plants), events that can be visible to a surveillance camera and recognized include a fire in a plant, machinery being jammed in a manufacturing line, and/or an item being mis-assembled in an assembly line.

The camera images 108 and the selected event labels 112 for each camera image 108 (e.g., each individual image and/or video segment) comprise a training data set 114. As shown, the training data set 114 is stored by the server 102; however, in some embodiments, the training data set 114 is stored outside of the server 102 and is accessed by the server, such as (without limitation) over a wired or wireless network.

The processor 104 executes the machine learning trainer 116 to train an event recognition model 118 using the training data set 114. The event recognition model 118 can be a neural network including a series of layers of neurons. In various embodiments, the neurons of each layer are at least partly connected to, and receive input from, an input source and/or one or more neurons of a previous layer. Each neuron can multiply each input by a weight; process a sum of the weighted inputs using an activation function; and provide an output of the activation function as the output of the artificial neural network and/or as input to a next layer of the artificial neural network. In some embodiments, the event recognition model 118 can include a convolutional neural network (CNN) in which convolutional filters that are applied by one or more convolutional layers to the input; memory structures, such as long short-term memory (LSTM) units or gated recurrent units (GRU); one or more encoder and/or decoder layers; or the like. For example, a deep convolutional neural network (CNN), such as a Res Net model, can be used as a “backbone” machine learning model that is trained to classify images for different tasks using a large dataset. Using the outputs of the last hidden layer as embeddings for a given input image, another machine learning model (e.g., a support vector machine (SVM)) can be trained using the positive and negative samples provided by the user for the event. The CNN model can be applied to one or more images from the camera 120 to generate embeddings, and the second classifier can be applied to the embeddings to determine an occurrence of the event. In various embodiments, the event recognition model 118 includes one or more other types of models, such as, without limitation, a Bayesian classifier, a Gaussian mixture model, a k-nearest-neighbor model, a decision tree or a set of decision trees such as a random forest, a restricted Boltzmann machine, or the like, or an ensemble of two or more event recognition models of the same or different types. In various embodiments, the event recognition model 118 can perform a variety of tasks, such as, without limitation, data classification or clustering, anomaly detection, computer vision (CV), semantic analysis, knowledge inference, or the like.

In some embodiments, the event recognition model 118 includes one or more binary classifiers, where each binary classifier outputs a probability of the training data sample to include an occurrence of an event of a particular event type. An occurrence of an event can be detected based on a maximum probability among the probabilities generated by the respective binary classifiers. In some other embodiments, the event recognition model includes a multi-class classifier that outputs, for a plurality of event types, a probability of the training data sample to include an occurrence of events of each of several event types. An occurrence of an event can be detected based on a maximum probability among the probabilities generated by the multi-class classifier for each of the event types. A CNN model can be applied to the images to generate the embeddings, and a second multi-class classifier is applied to determine an occurrence of any of the events.

In some embodiments, detection can be based on the maximum probability exceeding a probability threshold, e.g., a minimum probability at which confidence in the detection of an occurrence of the event is sufficient to prompt a response 126. Alternatively or additionally, in some embodiments, a “null” event type can be defined to indicate a non-occurrence of any of the events, and a determination of an occurrence of a “null” event (e.g., with the highest probability among the event types) can indicate a non-occurrence of the other event types. The “null” event type can reduce the incidence of false positives.

As shown, the machine learning trainer 116 is a program stored in the memory 106 and executed by the processor 104 to train the event recognition model 118. The machine learning trainer 116 trains the event recognition model 118 to output predictions of event labels 112 for camera images 108 included in the training data set 114. For each camera image 108 (e.g., each still image or video segment), the machine learning trainer 116 compares the event label 112 received through the user interface 110 with an event label 112 predicted by the event recognition model 118. If the associated event label 112 and the predicted event label 112 do not match, then the machine learning trainer 116 adjusts the internal weights of the neurons of the event recognition model 118. The machine learning trainer 116 repeats this weight adjustment process over the course of training until the prediction 124 of the event label 112 by the event recognition model 118 is sufficiently close to or matches with the event label 112 received through the user interface 110 for the camera image 108. In various embodiments, during training, the machine learning trainer 116 monitors a performance metric, such as a loss function, that indicates the correspondence between the associated event labels 112 and the predicted event labels 112 for each camera image 108 of the training data set 114. The machine learning trainer 116 trains the event recognition model 118 through one or more epochs until the performance metric indicates that the correspondence of the event labels 112 received through the user interface 110 and the predicted event labels 112 is within an acceptable range of accuracy. The trained event recognition model 118 is capable of making predictions 124 of event labels 112 for unlabeled camera images 108 in a manner that is consistent with the associations of the training data set 114.

In some embodiments, the machine learning trainer 116 can train the event recognition model 118 based on temporal information, such as the chronological sequence of two or more images in a video segment. In such embodiments, the event recognition model 118 can include, in addition to a “backbone” portion such as a convolutional neural network, one or more RNN based layers (including but not limited to LSTM cells) that capture the sequential nature of the data. In such embodiments, the short video clips or sequential frames tagged by the users can be used as samples and fed into the backbone portion of the event recognition model 118.

In some cases, two or more camera feeds 122 from two or more cameras 120 can be monitored to detect events, such as cameras at different locations within a facility. In some embodiments, the machine learning trainer 116 trains an event recognition model 118 based on the camera feeds 122 of a plurality of cameras 120. Similarly, in some embodiments, the system 100 applies an event recognition model 118 to the camera feeds 122 of a plurality of cameras 120. In some other embodiments, the machine learning trainer 116 trains an event recognition model 118 for each camera feed 122 of a subset of multiple cameras 120, including one camera 120 of the plurality of cameras 120. Similarly, in some embodiments, the system 100 applies a different event recognition model 118 to each camera feed 122 of a plurality of cameras 120, where the event recognition model 118 has been trained specifically on the camera feed 122 of the particular camera 120.

As shown, the processor 104 applies the event recognition model 118 to the camera feed 122 of the video camera 120 to generate predictions 124 including an indication of an occurrence of the event in the camera feed 122. Based on the prediction 124, the processor 104 performs a response 126.

Some embodiments of the disclosed techniques include different architectures than as shown in FIG. 1. As a first such example and without limitation, various embodiments include various types of processors 104. In various embodiments, the processor 104 includes a CPU, a GPU, a TPU, an ASIC, or the like. Some embodiments include two or more processors 104 of a same or similar type (e.g., two or more CPUs of the same or similar types). Alternatively or additionally, some embodiments include processors 104 of different types (e.g., two CPUs of different types; one or more CPUs and one or more GPUs or TPUs; or one or more CPUs and one or more FPGAs). In some embodiments, two or more processors 104 perform a part of the disclosed techniques in tandem (e.g., each CPU training the event recognition model 118 over a subset of the training data set 114) Alternatively or additionally, in some embodiments, two or more processors 104 respectively perform different parts of the disclosed techniques (e.g.. one CPU executing the machine learning trainer 116 to train the event recognition model 118, and one CPU applying the event recognition model 118 to the camera feed 122 of the camera 120 to make predictions 124).

As a second such example and without limitation, various embodiments include various types of memory 106. Some embodiments include two or more memories 106 of a same or similar type (e.g., a Redundant Array of Disks (RAID) array). Alternatively or additionally, some embodiments include two or more memories 106 of different types (e.g., one or more hard disk drives and one or more solid-state storage devices). In some embodiments, two or more memories 106 distributively store a component (e.g., storing the training data set 114 to span two or more memories 106). Alternatively or additionally, in some embodiments, a first memory 106 stores a first component (e.g., the training data set 114) and a second memory 106 stores a second component (e.g., the machine learning trainer 116).

As a third such example and without limitation, some disclosed embodiments include different implementations of the machine learning trainer 116. In some embodiments, at least part of the machine learning trainer 116 is embodied as a program in a high-level programming language (e.g., C. Java, or Python), including a compiled product thereof. Alternatively or additionally, in some embodiments, at least part of the machine learning trainer 116 is embodied in hardware-level instructions (e.g., a firmware that the processor 104 loads and executes). Alternatively or additionally, in some embodiments, at least part of the machine learning trainer 116 is a configuration of a hardware circuit (e.g., configurations of the lookup tables within the logic blocks of one or more FPGAs). In some embodiments, the memory 106 includes additional components (e.g., machine learning libraries used by the machine learning trainer 116).

As a fourth such example and without limitation, instead of one server 102, some disclosed embodiments include two or more servers 102 that together apply the disclosed techniques. Some embodiments include two or more servers 102 that distributively perform one operation (e.g., a first server 102 and a second server 102 that respectively train the event recognition model 118 over different parts of the training data set 114). Alternatively or additionally, some embodiments include two or more servers 102 that execute different parts of one operation (e.g., a first server 102 that displays the user interface 110 for a user, and a second server 102 that executes the machine learning trainer 116). Alternatively or additionally, some embodiments include two or more servers 102 that perform different operations (e.g., a first server 102 that trains the event recognition model 118 and a second server 102 that applies the event recognition model 118 to the camera feed 122 to make predictions 124). In some embodiments, two or more servers 102 communicate through a localized connection, such as through a shared bus or a local area network. Alternatively or additionally, in some embodiments, two or more servers 102 communicate through a remote connection, such as the Internet, a virtual private network (VPN), or a public or private cloud. In some embodiments, the system 100 and the video camera 120 are separate, and a communications network provides communication between the camera 120 and the system 100, The communications network can be a local personal area network (PAN), a wider area network (e.g., the internet) in cases of remote control of the camera 120, or the like. In various embodiments, training is performed by a device including the camera), at a cloud edge (e.g., on a gateway device or local server connected to the camera 120 via a local area network), and/or in the cloud (e.g., a separate machine outside of the local network which camera is connected to via a wide-area network such as the internet). Similarly, in various embodiments, prediction is performed by a device including the camera), at a cloud edge (e.g., on a gateway device or local server connected to the camera 120 via a local area network), and/or in the cloud (e.g., a separate machine outside of the local network which camera is connected to via a wide-area network such as the internet).

FIG. 2 is an illustration of a user interface 200 of the system of FIG. 1, according to some embodiments. In some embodiments, the user interface 200 is presented on a display of the system 100 and receives input via input devices of the system 100, such as (without limitation) a keyboard, mouse, and/or touchscreen. In some other embodiments, the user interface 200 is a web-based user interface that is generated by the system 100 and sent by a webserver to a client device, which presents the user interface within a web browser.

As shown, the user interface 200 enables a user to train an event recognition models 118 for new event types. The user interface 200 displays one or more images of a camera feed 122 of a camera 120. For example, the images of the camera feed 122 can be received by receiving an activation of buttons and recording a video clip for the sample from the camera feed 122, e.g., for an indicated length of time. The user interface 200 receives, from the user, a name for a new event type and an indication of three positive samples taken from the camera feed 122 (e.g., three images or video segments in which an occurrence of the event is visible) and an indication of three negative samples taken from the camera feed 122 (e.g., three images or video segments in which an occurrence of the event is not visible). The machine learning trainer 116 can then train an event recognition model 118 based on the positive samples and negative samples.

In some embodiments, the user interface 200 receives, from a user, a selection of a portion of the at least one image of at least one training data sample and the indication of the occurrence of the event within the portion. In some embodiments, the user indicates a spatial portion of an image in which the event occurs, such as a rectangular or free-form boundary designating an area of the image in which the occurrence of the event is visible. In some embodiments, the user indicates a spatial portion of a video segment in which the event occurs, such as a rectangular or free-form boundary designating an area of the video segment in which the event occurs, and/or a chronological portion of the video segment, such as a subset of the two or more images during which the event occurs. In at least these embodiments, the training can include training the event recognition model 118 to generate the indication of the occurrence of the event based on the selected portion of the at least one image.

Event detection is a superset of object detection and has a broader scope. For example (without limitation), some events may not involve a new object appearing or disappearing, but rather a change in the state of an object, such as a transition from a door being open to being closed. For example (without limitation), event detection can involve a configuration or orientation of an object, such as person raising her hand, or an interaction between two objects, such as a dog getting on a couch.

In some embodiments, the user interface 200 flags prior portions of the camera feed 122 (e.g., based on motion detection) as candidates for training samples. The user interface 200 can present the flagged candidates to a user for verification and/or labeling, and can use the flagged portions to train the event recognition model 118. These embodiments can make it easier to identify samples for the event of interest in the environment in which the camera 120 is intended to be used, which can simplify the training process for the user.

In some embodiments, the user interface 200 allows the user to create new event types. For example (without limitation), the user interface 200 receives from the user a tagging of one or more positive samples and/or one or more negative samples and an indication of the new event type that is represented by the one or more positive samples and not represented by the one or more negative samples. The user interface 200 can display, for the user, the video history or past motion alerts that might include positive and negative samples for each event type of interest. After an event type is created, the system 100 can train or retrain an event recognition model 118 for the new event type based on the user-provided samples.

In some embodiments, the user interface 200 allows the user to prioritize performance criteria for the event recognition model 118. For example (without limitation), the user interface 200 can allow the user to prioritize precision (e.g., the accuracy of identified events) for the event recognition model 118, where a higher precision reduces a likelihood of false positives. As another example (without limitation), the user interface 200 can allow the user to prioritize recall (e.g., the sensitivity to detecting events) for the event recognition model 118, where a higher recall reduces a likelihood of false negatives. In some cases, training the event recognition model 118 to produce higher precision vs. higher recall can be a tradeoff, and the user interface 200 can allow the user to specify such priorities in order to adapt the sensitivity of the event recognition model 118 to the circumstances of the user.

In some embodiments, the user interface 200 is part of a mobile app. For consumer surveillance cameras, a mobile app allows users to monitor the real time camera feed 122 of the camera 120 as well as short video segments corresponding to recent events (motion alerts, person detection, etc.) In some embodiments, the user interface 200 includes a page that is designed in the mobile app to allow the user to define a custom event and to tag positive and negative samples (e.g. using either the live stream or using the short video segments recorded in the recent alert section).

The event recognition model 118 is trained or retrained based on the user selections in the user interface 200. In various embodiments, the training or retraining is performed directly on the system 100 or on a remote server. In some embodiments, the machine learning trainer 116 uses a few-shot learning framework. The use of few-shot learning allows the event recognition model 118 to be trained with relatively few training data samples, such as three positive and three negative training data samples, as discussed with respect to FIG. 2. In some embodiments, training can be limited, for example, to a selected number of training data samples of events of interest (e.g., ten samples for each event type).

In some embodiments, the machine learning trainer 116 can retrain the event recognition model 188 by applying higher training weights to the samples provided by the user for a specific camera. Applying higher training weights to the samples provided by the user for a specific camera can be advantageous for improving the detection of occurrences of events by the camera according to samples provided by the user. Also, in some embodiments, retraining can be performed based on explicit or implicit feedback from a user regarding alerts generated by a pretrained model.

In some embodiments, the system 100 has access to a set of pretrained models. The pretrained models can provide basic recognition of predefined event types, such as common types of human or animal movement. In some embodiments, the pretrained models can be hosted by the system 100 and made available to all users who have access to the system 100. In some embodiments, the system 100 receives a selection by the user of one or more of the predefined event types that are of interest to the user, and then uses one or more pretrained models as the event recognition model 118 for the camera 120 of the user. In some embodiments, the pretrained models are used as base models to generate embeddings that are further used to train the specific models on the camera feed 122 of the camera 120. That is, a pretrained model can be generally trained to detect a presence of a person, and an event recognition model 118 can continue training of a pretrained model using images from the camera feed 122 of a particular camera 120. Using a pretrained model can accelerate the training of the event recognition model 118 and/or can allow the training of the event recognition model 118 to be completed with fewer data samples of the events of interest. Also, continuing the training of a pretrained model using the camera feed of a particular camera can adapt the learned criteria of the pretrained model for detecting occurrences of the event to the specific details of the particular camera.

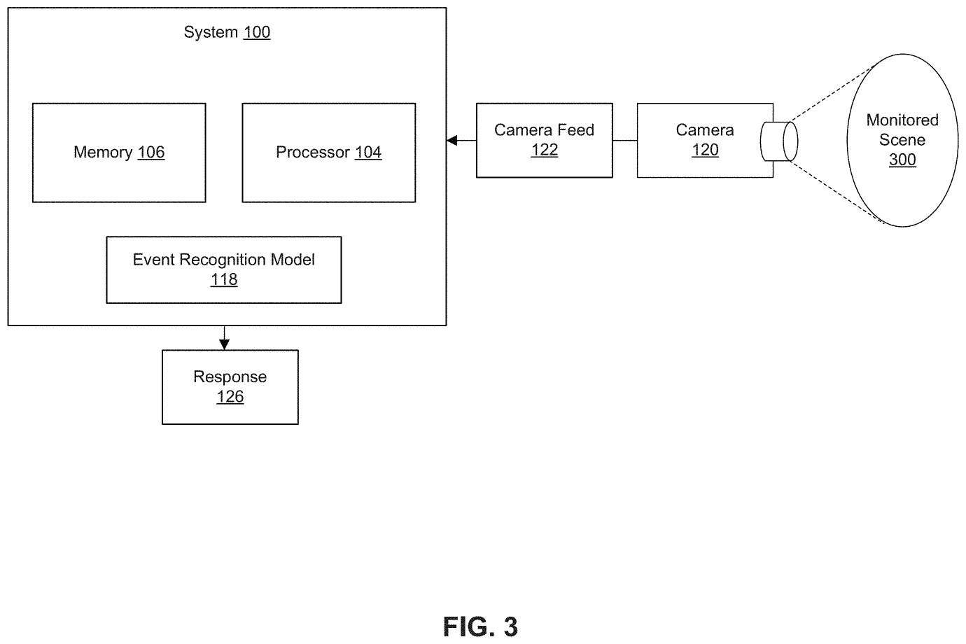

FIG. 3 is an illustration of the system 100 of FIG. 1 detecting events in a monitored scene, according to some embodiments. The system 100 of FIG. 3 includes a processor 104, memory 106, and an event recognition model 118, and interacts with a camera 120.

As shown, the camera 120 provides a camera feed 122 of a monitored scene 300. The system 100 applies the event recognition models 118 and/or pretrained models to the camera feed 122 of a camera 120 recognize the custom events of interest to the user. The system 100 performs a response 126 based on the indication by the event recognition model 118 of an occurrence of the event in the camera feed 122 of the monitored scene 300. In some embodiments, the response 126 includes alerting a user of the occurrence of events or otherwise taking actions in reaction to the events. In some embodiments, the system 100 takes an appropriate action in response to the recognition of a custom event type by the event recognition model 118, such as sending an alert to the user or a first responder, activating an alarm (e.g., playing a sound), controlling a portion of the user's premises (in the case of smart homes, businesses, or factories), or the like. In some embodiments, the system 100 includes a user interface module that provides a user interface by which the user can interact with the camera 120, e.g., to zoom, pan, or tilt the camera 120 and/or to adjust camera properties such as exposure or resolution.

When a motion is detected within the camera feed 122 of the camera 120, the event recognition model 118 is applied to determine if any of the events of interest to the user are occurring. In some embodiments, the system 100 continuously and/or in real time applies an event recognition model 118 to a camera feed 122 from the camera 120. In some other embodiments, the system 100 applies the event recognition model 118 to past camera feeds, such as time-delayed analysis or historic analysis. In some embodiments, the system 100 applies the event recognition model 118 to the camera feed 122 only after motion is detected (e.g., in order to minimize computation costs). For example (without limitation), the system 100 can detect motion via a passive infrared (PIR) sensor, and can apply the event recognition model 118 only when or after the PIR sensor detects motion. As another example, the system 100 can compare two or more images (e.g., consecutive frames) in a camera feed 122 on a pixel-by-pixel and/or area-by-area basis. A change in the pixels that is greater than a threshold can be considered to indicate motion, resulting in applying the event recognition model 118 to the camera feed 122.

When the event recognition model 118 detects an occurrence of its associated event, the system 100 performs a response 126. In some embodiments, the response 126 includes an action, such as (without limitation) alerting the user by beeping/playing a sound/sending a message. In some embodiments, the response 126 includes a remedial action, such as sending an emergency call to a first responder such as police, firefighters, healthcare providers, or the like. In some embodiments, the response 126 includes controlling a location of the monitored scene 300, such as activating an alarm, locking doors of a smart home, and/or shutting off power to certain parts of the home.

In some embodiments, an event recognition model 118 can be retrained. In some embodiments, the system 100 retrains the event recognition model 118 based on an identification of instances where the event recognition model 118 in question was incorrect. In such cases, retraining can include receiving (e.g., from a user) an updated indication of an occurrence of an event within a first training data sample of the training data set 114, and re-training the event recognition model 118 to generate predictions 124 (e.g., an updated event label 112) of the updated indication of the occurrence of the event for the first training data sample. That is, the user interface 200 can receive from the user an indication of a false positive (e.g., the event recognition model 118 incorrectly predicts an event is occurring while it is not), such as one or more tags indicating false detection. The machine learning trainer 116 can use the tags and the tagged one or more images as negative samples to retrain the event recognition model 118 to refrain from detecting non-occurrences of the event. As another example, the updated indication can include an indication of an occurrence of the event in the first training data sample for which the event recognition model failed to generate an indication of the occurrence of the event (e.g., a false negative). That is, the user interface 200 can receive from the user an indication of a false negative (e.g., a failure to detect an occurrence of event), such as one or more tags indicating failed detection, These identified instances can serve as a negative training set that can be used to re-train the event recognition model 118 for greater accuracy. The machine learning trainer 116 can use the tags and the tagged one or more images as positive samples to retrain the event recognition model 118 to detect occurrences of the event. As yet another example, the updated indication can include an indication of a non-occurrence of the event in the first training data sample for which the event recognition model incorrectly generated an indication of an occurrence of the event (e.g., a false positive). As yet another example, the updated indication can include an identification of a first event type for the occurrence of the event for which the event recognition model 118 determined a second event type (e.g., a correction of the event type determined by the event recognition model 118 for a selected training data sample). For example (without limitation), the updated indication can include a new event type for the occurrence of the event (e.g., a new event type as selected by a user). In these and other cases, re- training can involve continued training of a current event recognition model 118 and/or training a new event recognition model 118 to replace a current event recognition model 118. In some embodiments, the user can delete a subset of (positive and negative) training data samples of the training data set 114 (e.g., samples that are incorrect and/or ambiguous). In such cases, a new event recognition model 118 can be trained using the updated training data set 114.

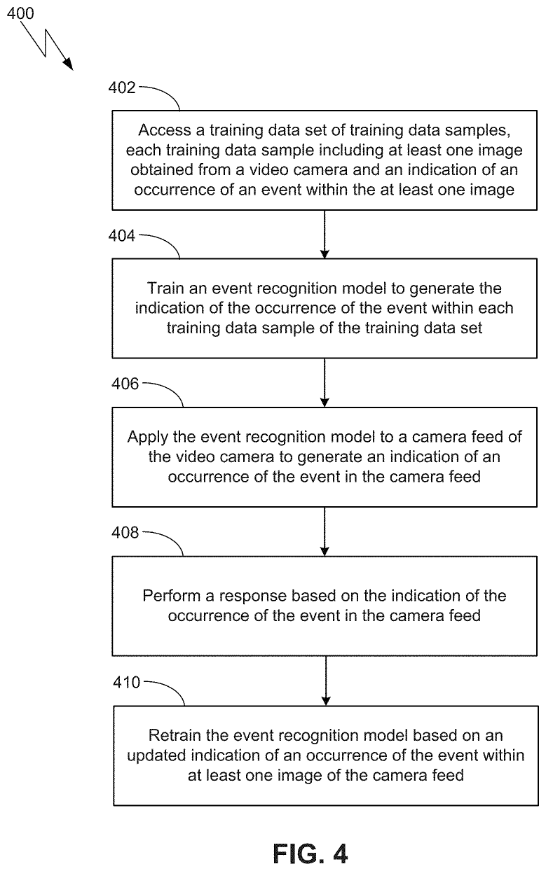

FIG. 4 is a flow diagram of method steps for detecting events by a video camera, according to one or more embodiments. Although the method steps are described with reference to FIGS. 1-3, persons skilled in the art will understand that any system may be configured to implement the method steps, in any order, in other embodiments.

As shown, at step 402, a training data set of training data samples is accessed, wherein each training data sample includes at least one image obtained from a video camera and an indication of an occurrence of an event within the at least one image. For example (without limitation), the video camera can provide one or more individual images and/or one or more video segments including a sequence of two or more images. In some embodiments, the training data set is generated by presenting the training data samples through a user interface and receiving, from a user, a selection of an event label as an indication of an event occurring in each training data sample.

As shown, at step 404, an event recognition model is trained to generate the indication of the occurrence of the event within each training data sample of the training data set. In some embodiments, the event recognition model includes one or more binary classifiers, where each binary classifier outputs a probability of the training data sample to include an occurrence of an event of a particular event type. In some other embodiments, the event recognition model includes a multi-class classifier that outputs, for a plurality of event types, a probability of the training data sample to include an occurrence of events of each of several event types. In some embodiments, training is performed using a few-shot learning framework, which enables the event recognition model to be trained using a small number of samples per event type.

As shown, at step 406, the event recognition model is applied to a camera feed of the video camera to generate an indication of an occurrence of the event in the camera feed. In various embodiments, the camera feed is an individual image and/or a sequence of two or more images. In some embodiments, the camera feed is a live camera feed. In some embodiments, the indication of the occurrence of the event is generated based on a probability of the occurrence of the event in the camera feed, and, further, based on the probability exceeding a probability threshold.

As shown, at step 408, a response is performed based on the indication of the occurrence of the event in the camera feed. In various embodiments, the response includes one or more of sending an alert to the user or a first responder, activating an alarm (e.g., playing a sound), controlling a portion of the user's premises (in the case of smart homes, businesses, or factories), or the like.

As shown, at step 410, the event recognition model is retrained based on an updated indication of an occurrence of the event within at least one image of the camera feed. For example (without limitation), the updated indication can be an indication of an occurrence of the event within an individual image or video segment for which the event recognition model did not determine the occurrence of the event. As another example (without limitation), the updated indication can be an indication of a non-occurrence of the event within an individual image or video segment for which the event recognition model incorrectly determined an occurrence of the event. As yet another example (without limitation), the updated indication can be an indication of a new event type for which an occurrence is visible within an individual image or video segment, or a different event type than was detected by the event recognition model. In such cases, the retraining can involve continuing the previous training of the event recognition model using the updated indication, or training a substitute event recognition model to be used in place of the current event recognition model.

In sum, an event recognition model is trained to recognize occurrences of events in images from a camera based on user-selected event labels for events as indicated by user. The trained event recognition model is applied to a camera feed of the camera to generate indications of occurrences of the events of interest to the user. A response is performed based on determined occurrences of the events.

At least one technical advantage of the disclosed techniques is that the event recognition model is trained to detect specific types of events that indicated by the user. Training the event recognition model based on events that are of interest to the user can expand and focus the range of detected event types to those that are of particular interest to the user, and to exclude events that are not of interest to the user. As another advantage, training the event recognition model on the camera feed of a camera can enable the camera to detect events within the particular context of the camera and camera feed, such as a particular room of a house or area of a factory. As yet another advantage, performing responses based on the trained event recognition model can enable a surveillance system to take event-type-specific responses based on the events of interest to the user. These technical advantages provide one or more technological improvements over existing techniques for event detection for surveillance cameras.

[Claim combinations to be inserted by Artegis prior to filing]

One possible embodiment has been described herein. Those of skill in the art will appreciate that other embodiments may likewise be practiced. First, the particular naming of the components and variables, capitalization of terms, the attributes, data structures, or any other programming or structural aspect is not mandatory or significant, and the mechanisms described may have different names, formats, or protocols. Also, the particular division of functionality between the various system components described herein is merely for purposes of example, and is not mandatory; functions performed by a single system component may instead be performed by multiple components, and functions performed by multiple components may instead be performed by a single component.

Some portions of the above description present the inventive features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects described herein include process steps and instructions in the form of an algorithm. It should be noted that the process steps and instructions could be embodied in software, firmware or hardware, and when embodied in software, could be downloaded to reside on and be operated from different platforms used by real time network operating systems.

The concepts described herein also relate to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the concepts described herein are not described with reference to any particular programming language. It is appreciated that a variety of programming languages may be used to implement the teachings as described herein, and any references to specific languages are provided for purposes of enablement and best mode.

The concepts described herein are well suited to a wide variety of computer network systems over numerous topologies. Within this field, the configuration and management of large networks comprise storage devices and computers that are communicatively coupled to dissimilar computers and storage devices over a network, such as the Internet.

It should be noted that the language used in the specification has been principally selected for readability and instructional purposes, and may not have been selected to delineate or circumscribe the inventive subject matter. Accordingly, the disclosure is intended to be illustrative, but not limiting, of the scope of the concepts described herein, which are set forth in the following claims.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed, Many modifications and variations will be apparent to those of ordinary skill in the art without departing from the scope and spirit of the described embodiments.

Aspects of the present embodiments may be embodied as a system, method or computer program product, Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for detecting events by a video camera, the method comprising:
accessing a training data set of training data samples, each training data sample including at least one image obtained from the video camera and an indication of an occurrence of an event within the at least one image;
training an event recognition model to generate the indication of the occurrence of the event within each training data sample of the training data set;
applying the event recognition model to a camera feed of the video camera to generate an indication of an occurrence of the event in the camera feed; and
performing a response based on the indication of the occurrence of the event in the camera feed.

2. The computer-implemented method of claim 1, wherein accessing the training data set includes receiving, from a user, a selection of a portion of the at least one image of at least one training data sample and the indication of the occurrence of the event within the portion, and the training includes training the event recognition model to generate the indication of the occurrence of the event based on the portion of the at least one image.

3. The computer-implemented method of claim 1, wherein the training data set includes a first set of training data samples for a first event type and a second set of training data samples for a second event type, and the training includes training the event recognition model to determine an event type of the occurrence of the event within each training data sample as one of the first event type or the second event type.

4. The computer-implemented method of claim 1, wherein the training data set includes training data samples for a predefined event type, and the training includes training a pretrained event recognition model that has been pretrained to determine occurrences of events of the predefined event type.

5. The computer-implemented method of claim 1, further comprising:
receiving an updated indication of the occurrence of the event within a first training data sample; and
re-training the event recognition model to generate the updated indication of the occurrence of the event for the first training data sample.

6. The computer-implemented method of claim 5, wherein the updated indication includes at least one of,
an indication of an occurrence of the event in the first training data sample for which the event recognition model failed to generate an indication of the occurrence of the event,
an indication of a non-occurrence of the event in the first training data sample for which the event recognition model incorrectly generated an indication of an occurrence of the event,
an identification of a first event type for the occurrence of the event for which the event recognition model determined a second event type, or
a new event type for the occurrence of the event.

7. The computer-implemented method of claim 1, wherein the response includes at least one of, sending an alert to a user, sending an alert to a first responder, or activating an alarm.

8. One or more non-transitory computer readable media storing instructions that, when executed by one or more processors, cause the one or more processors to perform the steps of:
accessing a training data set of training data samples, each training data sample including at least one image obtained from a video camera and an indication of an occurrence of an event within the at least one image;
training an event recognition model to generate the indication of the occurrence of the event within each training data sample of the training data set;
applying the event recognition model to a camera feed of the camera feed to generate an indication of an occurrence of the event in the camera feed; and
performing a response based on the indication of the occurrence of the event in the camera feed.

9. The one or more non-transitory computer readable media of claim 8, wherein accessing the training data set includes receiving, from a user, a selection of a portion of the at least one image of at least one training data sample and the indication of the occurrence of the event within the portion, and the training includes training the event recognition model to generate the indication of the occurrence of the event based on the portion of the at least one image.

10. The one or more non-transitory computer readable media of claim 8, wherein the training data set includes a first set of training data samples for a first event type and a second set of training data samples for a second event type, and the training includes training the event recognition model to determine an event type of the occurrence of the event within each training data sample as one of the first event type or the second event type.

11. The one or more non-transitory computer readable media of claim 8, wherein the training data set includes training data samples for a predefined event type, and the training includes training a pretrained event recognition model that has been pretrained to determine occurrences of events of the predefined event type.

12. The one or more non-transitory computer readable media of claim 8, the steps further comprising:
receiving an updated indication of the occurrence of the event within a first training data sample; and
re-training the event recognition model to generate the updated indication of the occurrence of the event for the first training data sample.

13. The one or more non-transitory computer readable media of claim 12, wherein the updated indication includes at least one of,
an indication of an occurrence of the event in the first training data sample for which the event recognition model failed to generate an indication of the occurrence of the event,
an indication of a non-occurrence of the event in the first training data sample for which the event recognition model incorrectly generated an indication of an occurrence of the event,
an identification of a first event type for the occurrence of the event for which the event recognition model determined a second event type, or
a new event type for the occurrence of the event.

14. The one or more non-transitory computer readable media of claim 8, wherein the response includes at least one of, sending an alert to a user, sending an alert to a responder, or activating an alarm.

15. A system, comprising:
a memory that stores instructions, and
a processor that is coupled to the memory and, when executing the instructions, is configured to:
access a training data set of training data samples, each training data sample including at least one image obtained from a video camera and an indication of an occurrence of an event within the at least one image;
train an event recognition model to generate the indication of the occurrence of the event within each training data sample of the training data set;
apply the event recognition model to a camera feed of the video camera to generate an indication of an occurrence of the event in the camera feed; and
perform a response based on the indication of the occurrence of the event in the camera feed.

16. The system of claim 15, wherein accessing the training data set includes receiving, from a user, a selection of a portion of the at least one image of at least one training data sample and the indication of the occurrence of the event within the portion, and the training includes training the event recognition model to generate the indication of the occurrence of the event based on the portion of the at least one image

17. The system of claim 15, wherein the training data set includes a first set of training data samples for a first event type and a second set of training data samples for a second event type, and the training includes training the event recognition model to determine an event type of the occurrence of the event within each training data sample as one of the first event type or the second event type.

18. The system of claim 15, wherein the training data set includes training data samples for a predefined event type, and the training includes training a pretrained event recognition model to determine occurrences of events of the predefined event type.

19. The system of claim 15, wherein the processor is further configured to:
receive an updated indication of the occurrence of the event within a first training data sample; and
re-train the event recognition model to generate the updated indication of the occurrence of the event for the first training data sample.

20. The system of claim 19, wherein the updated indication includes at least one of,
an indication of an occurrence of the event in the first training data sample for which the event recognition model failed to generate an indication of the occurrence of the event,
an indication of a non-occurrence of the event in the first training data sample for which the event recognition model incorrectly generated an indication of an occurrence of the event,
an identification of a first event type for the occurrence of the event for which the event recognition model determined a second event type, or
a new event type for the occurrence of the event.

21. The system of claim 15, wherein the response includes at least one of, sending an alert to a user, sending an alert to a responder, or activating an alarm.
